(19) United States
(12) Patent Application Publication
(10) Pub. No.: US 2021/0004711 A1
(43) Pub. Date: Jan. 7, 2021

(54) COGNITIVE ROBOTIC PROCESS AUTOMATION

(71) Applicant: INTERNATIONAL BUSINESS MACHINES CORPORATION, ARMONK, NY (US)

(72) Inventors: Anuj Gupta, New Dehli (IN); Vijay Chandra Srinivas Telukapalli, Karnataka (IN); Senthilkumaran Balasubramaniyan, BANGALORE (IN)

(21) Appl. No.: 16/459,838

(22) Filed: Jul. 2, 2019

(51) Int. Cl. G06N 20/00; G06N 5/02

(52) U.S. Cl. CPC G06N 20/00; G06N 5/02

(57) ABSTRACT

A computer-implemented method includes automatically generating, using machine learning, a data structure that stores a knowledge graph for a decision making process that is to be automated. The knowledge graph includes one or more entities, one or more states of each of the entities, and transitions for each of the states. The method further includes creating, from the knowledge graph, a decision tree that represents conditions for one or more parameters that cause the entities to transition from one state to another. The method further includes automatically generating a conversation flow and performing a machine-human conversation with a user to obtain values of the parameters using dialogs from the conversation flow to converse with the user. The method further includes executing the process automatically by traversing the decision tree using the values of the parameters. The method further includes notifying the user of a result of executing the process.

### BACKGROUND

The present invention generally relates to computer technology, and more specifically, to automating a process by identifying human intervention and manual steps and creating rules and incorporating such rules into the process.

One of the key drivers for digital transformation of an organization is digital process automation of one or more processes that are performed in/by the organization. Robotic Process Automation (RPA) handles complex, long-running processes in several cases. Such RPA projects tend to require extensive upfront modeling, followed by long development cycles to implement the process to be performed digitally, such as using one or more electronic devices. Primary motivation of RPA was cost reduction however, today, customer experience is also a focus when implementing RPA. As objectives for the process of implementing RPA shift to digital transformation and customer experience, the focus shifts to customer outcomes such as immediate gratification, personalized service delivery, and the like. While RPA helps in improving costs in the short term, enterprises also desire to transform their processes, resulting in more agile and data/insight driven organizations so that they can rapidly adapt and respond to ever changing scenarios.

### SUMMARY

A computer-implemented method includes automatically generating, using machine learning, a data structure that stores a knowledge graph for a decision making process that is to be automated. The knowledge graph includes one or more entities, one or more states of each of the entities, and transitions for each of the states. The knowledge graph is generated automatically based on execution logs of the decision making process. The method further includes creating, from the knowledge graph, a decision tree that represents conditions for one or more parameters that cause the entities in the knowledge graph to transition from a first state to a second state. The method further includes automatically generating a conversation flow to obtain values for the one or more parameters. The method further includes performing, via a graphical user interface, a machine-human conversation with a user to obtain the values of the one or more parameters, the machine-human conversation comprising one or more dialogs from the conversation flow to converse with the user. The method further includes executing the process automatically by traversing the decision tree using the values of the one or more parameters. The method further includes notifying the user of a result of executing the process.

According to one or more embodiments of the present invention, a system includes a memory, and a processor coupled with the memory. The processor performs a method for automating a decision making process. The method includes automatically generating, using machine learning, a data structure that stores a knowledge graph for a decision making process that is to be automated. The knowledge graph includes one or more entities, one or more states of each of the entities, and transitions for each of the states. The knowledge graph is generated automatically based on execution logs of the decision making process. The method further includes creating, from the knowledge graph, a decision tree that represents conditions for one or more parameters that cause the entities in the knowledge graph to transition from a first state to a second state. The method further includes automatically generating a conversation flow to obtain values for the one or more parameters. The method further includes performing, via a graphical user interface, a machine-human conversation with a user to obtain the values of the one or more parameters, the machine-human conversation comprising one or more dialogs from the conversation flow to converse with the user. The method further includes executing the process automatically by traversing the decision tree using the values of the one or more parameters. The method further includes notifying the user of a result of executing the process.

According to one or more embodiments of the present invention, a computer program product includes a computer readable storage medium having program instructions embodied therewith. The program instructions are executable by a processing circuit to cause the processing circuit to perform a method for automating a decision making process. The method includes automatically generating, using machine learning, a data structure that stores a knowledge graph for a decision making process that is to be automated. The knowledge graph includes one or more entities, one or more states of each of the entities, and transitions for each of the states. The knowledge graph is generated automatically based on execution logs of the decision making process. The method further includes creating, from the knowledge graph, a decision tree that represents conditions for one or more parameters that cause the entities in the knowledge graph to transition from a first state to a second state. The method further includes automatically generating a conversation flow to obtain values for the one or more parameters. The method further includes performing, via a graphical user interface, a machine-human conversation with a user to obtain the values of the one or more parameters, the machine-human conversation comprising one or more dialogs from the conversation flow to converse with the user. The method further includes executing the process automatically by traversing the decision tree using the values of the one or more parameters. The method further includes notifying the user of a result of executing the process.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a block diagram of a system for automating a process cognitively according to one or more embodiments of the present invention;

FIG. 4 illustrates a flowchart of a process execution by a robotic process automation (RPA) system according to one or more embodiments of the present invention;

FIG. 5 depicts a system that can be used as a computing device to implement one or more components or a combination thereof according to one or more embodiments of the present invention;

FIG. 6 depicts a flowchart of a method for automating execution of a process that includes decision making according to one or more embodiments of the present invention; and

FIGS. 7, 8 and 9 depict parts of an example user interface according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Traditionally, developing computer products, such as software, for implementing RPA, is performed in isolation to one or more decision making processes that the RPA automates. For example, RPA automates repetitive human tasks, however, the core of any process is decision making, which is achieved through a combination of RPA, rules, and human intervention for the decision making. Such development of RPA alone for process automation requires human intervention, which leads to discontinuous automation.

Another technical challenge with implementing the development of computer products for RPA is that process reengineering and the automation are seen as separate activities. Therefore, typically, process reengineering and optimization is done by a set of people, such as consultants, followed by use of RPA and other technologies for automation. This multistage manual approach in process optimization, process design, and implementation, results in time lag, gap between requirements and what actually is designed and executed. Manual generation of rules for the process operations is both time consuming and error prone. Many rules become redundant and can add confusing complexity to the RPA system.

To address such technical challenges during the development of an RPA system, presently, during the modelling activities, an analyst or a subject matter expert (SME) of the process that is being automated identifies a chain of events/tasks/rules required to accomplish the task/goal of the process. A big drawback of such an implementation is that the process flow depends solely on the static rules defining the process. Use of the RPA system developed in this manner automates the task, however the flow remains the same, unless the design time wiring/operations are changed. Typically, there is no real-time feedback loop from execution of the process using the RPA system. In this process re-engineering is seen as a onetime activity, and by the time the process is implemented and automated by the RPA system, the process can be already outdated.

For example, consider an example scenario of a travel request approval process in an organization. Let us assume that when modeling such an process, the following decisions are to be made, although, it should be noted that this is just one example scenario, and that embodiments of the present invention are not limited to this example scenario:

a. Purpose of travel? Finalizing Deal/Maintenance

b. If it is finalizing a deal, what is an opportunity number associated with the deal?

c. Based on the opportunity number list out the skills associated with the opportunity

d. Identifying if the skills are available locally at the site of the deal

e. 1. If yes, the system prompts to use the local skill; 2. If no, the system passes the request to the concerned team for approval.

While this process can work for most cases, it does not account for external influencing factors. For example, time of travel, whether the request is being made during a particular decision making cycle (e.g. Annual quarter 3/quarter 4), funding issues, travel required to close a deal for the current quarter, and if required approval exists. For example, a policy indicating approval for strategic customers can be enforced if the travel is happening in Quarter 1 and Quarter 3 and this is generally done by manual intervention. With manual intervention one disadvantage is the time taken for the decision might be delayed. Also, the user submitting the application/request for travel does not receive a transparent decision making picture as to why one request was approved and why another was not approved. For example, consider that for two requests associated with a deal size of more than a threshold, such as USD 100K, one travel request is approved and another is rejected. Here, the deciding factor may be which quarter the deal is being closed. For example, even if the deal size is more than 100K, because the deal is closing in the next quarter (say Q4), the travel request for this quarter is rejected.

For some cases an exception approval has to be raised even though all the information exists within the same process. In these cases, the efficiency of the RPA system deteriorates because of external factors, which are influencing the process, and which were not incorporated during the time of the RPA implementation. Such scenarios not only result in increased time for decision making, but also negatively impact customer sentiment.

Accordingly, the process that includes human intervention lags behind in terms of speed and the one or more people have to babysit the RPA system implementing the process, which is ineffective and can be a bottle neck. While manual intervention cannot be totally ruled out, a technical need exists to create a solution that can act as a catalyst in speeding up the process. A solution that complements the existing process by providing decisions or recommendations is needed. Such a solution can either be manifested as an addendum or be an actual part of an RPA system.

One or more embodiments of the present invention are rooted in computing technology, particularly software development. One or more embodiments of the present invention improve existing solutions of RPA development and accordingly result in an improved RPA system.

One or more embodiments of the present invention provide technical solutions to at least such technical challenges and further advantages provided will be evident from the description that follows. The one or more embodiments described herein accordingly improve at least robotic process automation and facilitate improvements in computer rooted technology.

One or more embodiments of the present invention are not only limited to process automation, but also to optimize a process and decision-making using machine learning or artificial intelligence (AI). Accordingly, the RPA system developed using one or more embodiments of the present invention is referred to as “cognitive RPA” herein. Further, one or more embodiments of the present invention facilitate deriving actionable, real-time insights from operations intelligence to augment the formulation, orchestration, and automation of adaptive business processes. Cognitive RPA formulates and orchestrates processes that reshape themselves as they run. These processes are data driven, adaptive, and intelligent, and automatically execute the next optimal action based on context formation from data, instead of the same repeatable sequence of actions. Accordingly, using this approach one or more embodiments of the present invention address the digital transformation of an organization, keeping into consideration an integrated approach for process reengineering and automation focused on business outcome.

One or more embodiments of the present invention can be implemented using a cloud-based computing system. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

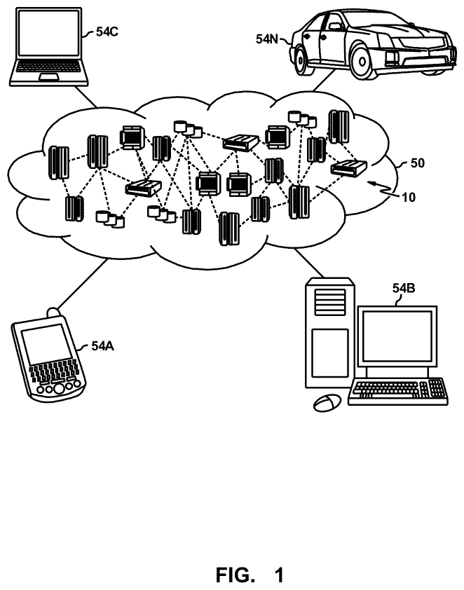

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

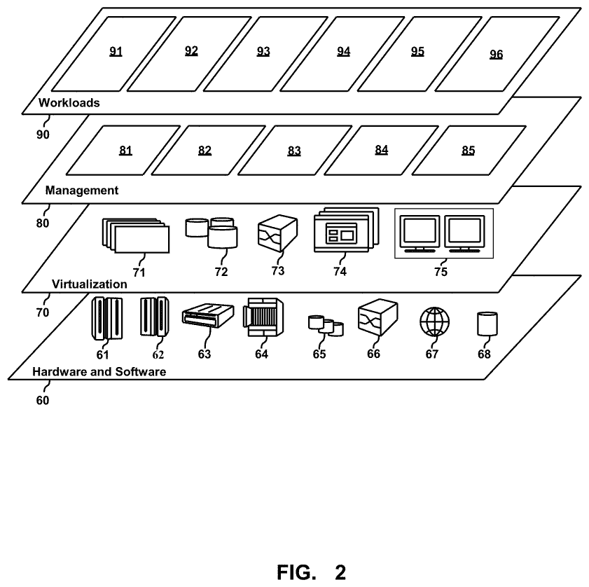

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and implementing RPA system 96.

A typical optimization of a process after identifying the human intervention/manual steps is to create rules for the manual steps and incorporating them into the process. As described earlier, such rules are static and fail to capture the dynamic nature of decision making that can be performed in such manual steps. One or more embodiments of the present invention address such technical challenges by using artificial intelligence to perform the decision making. For implementing an RPA system with such an artificial intelligence, one or more embodiments of the present invention perform a data mining of existing instance of process executions to automatically identify the operations, sequence of operations, data flow, and pre-conditions, post conditions, and external invocations. Further, a hierarchical tree is created that captures the states, transitions between states, and actions required to transition between the states. According to one or more embodiments of the present invention, the construction of hierarchical tree is based on the patterns from the previous executions of the process using a machine learning process that is done based on the logs generated by the process. Depending upon the frequency of the nodes visited during the earlier executions of process, weights are allotted and the hierarchical tree is derived.

Further, automated mapping of the artifacts to intents and entities is performed based on the hierarchical tree and further one or more dialog nodes are created. Further yet, based on one or more external system changes, a context variable is populated that determines the flow of control in the hierarchical tree.

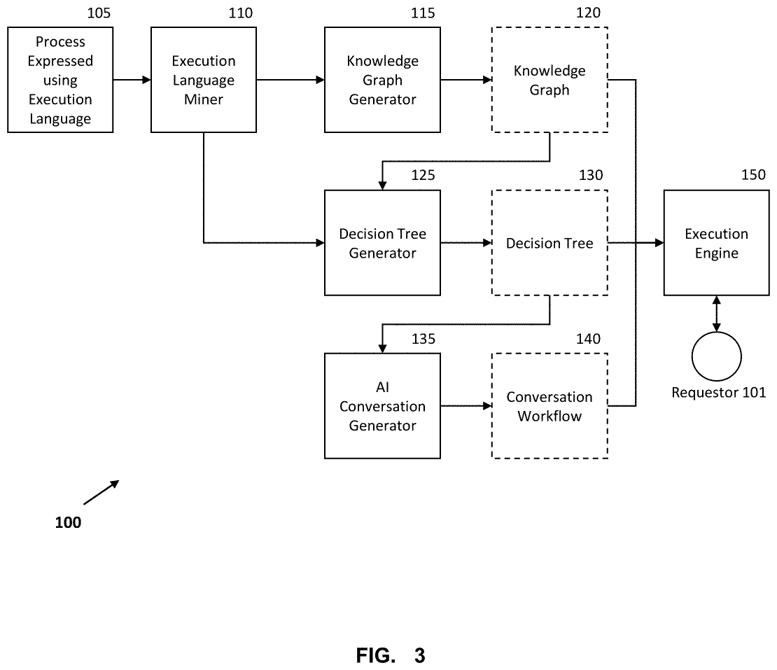

FIG. 3 depicts a block diagram of a system for automating a process cognitively according to one or more embodiments of the present invention. The system 100 facilitates not only automation of a process, but also facilitates optimizes the process and decision-making that is part of executing the method using artificial intelligence (AI). The system 100 derives actionable, real-time insights from operations intelligence to augment the formulation, orchestration, and automation of an adaptive process. The system 100 further facilitates a cognitive RPA that formulates and orchestrates processes that reshape themselves as they run. These processes are data driven, adaptive, and intelligent, determining and executing a next action based on context formation from data, instead of the same repeatable sequence of actions. In other words, using the cognitive RPA, the system 100 automatically determines a sequence of operations in the process that is to be executed based on one or more data input from the user along with several contextual restrictions that the system 100 automatically detects. The system 100 facilitates such a digital transformation of the process by using an integrated approach for process re-engineering and automation, which is focused on an outcome of the process.

The system includes a knowledge graph generator 115 that automatically generates a knowledge graph 120 using machine learning and deep learning techniques to identify the changes that happen using one or more of records, time series data, raw events. In one or more examples, such data representing a process (process-representation 105) that is to be automated is stored using a structured format such as a metalanguage, for example, extendable markup language (XML), business process execution language (BPEL), a Business Process Model and Notation (BPMN), etc. The data representing the process can include one or more entities present in the process and relationships between entities that influence the process. Such data can be electronically/digitally stored in the form of BPEL/BPMN, web service description language (WSDL), java connector architecture (JCA) files, etc. Such data is henceforth referred to as process-representation 105 and includes various systems-of-records (databases & documents) like policies, regulation, streaming events, feeds etc. related to the process when the data is being executed with manual intervention.

The system 100 includes an execution language miner 110 (miner) that parses and analyzes the process representation to identify and extract one or more entities, corresponding attributes, and relationships among such entities from the process-representation 105. In one or more examples, the miner 110 parses a sequence of events that are performed for executing the process with manual intervention. Further, based on the parsing the miner 110 determines a static workflow of the process by identifying a pattern of events that are performed during prior executions of the process. It should be noted that determining a pattern of events to perform such a static interpretation of the process is known in the art.

The knowledge graph generator 115 automatically generates the knowledge graph 120 using the one or more entities, attributes, and relationships that are extracted by miner 110. For example, the knowledge graph generator 115 stores in the knowledge graph 120, details for each entity such as name of entity, attributes of the entity, static relationship between two or more entities. For example, in the earlier example described related to a travel request, entities created and stored in the knowledge graph 120 can include: entity-name=TravelRequest, entity-attributes=travelType, dateofOnwardJourney, dateofReturnJourney, origin, destination, etc. Further, a static relationship between entities is created, for example, in this case, a relationship may exist between the TravelRequest entity and a TravelPreApprovalRequest entity. Such relationships are derived by the miner 110 from the mined process-representation 105.

Further, the knowledge graph generator 115 analyzes the mined data to identify the interaction points of the RPA system 100 with the other systems, like webservices, while executing the process. According to one or more embodiments of the present invention, to determine the webservice interactions from the process-representation 105, the knowledge graph generator 115 identifies the occurrences of particular elements, for example, in case the process-representation 105 is in BPEL, an element partnerLink is identified. Such elements identify the webservice interaction and the information that is retrieved can include name of the webservice (e.g. AirlineReservationService), wsdl file associated with the webservice (e.g. AirlineReservationService.wsdl), and name of the role in BPEL (e.g. AirlineReservationServiceRole).

In one or more examples, the knowledge graph generator 115 further parses the WSDL file to identify attributes of the webservice such as portname, operation name, input message, output message, fault message, mode of operation like request-response or notification service are derived from the WSDL file.

Further, interaction of process-representation 105 with system of records like databases, Java message services (JMS), packaged applications etc., is done through one or more adapters exposed as wsdl/JCA compliant resource adapters. The information can be retrieved from a BPEL file, a JCA file, and SCA file or any other data representation that includes at least the information of table name, queried column info, and schema details. For example, the information can be tablename=travelDB; columnName: origin, destination. The retrieved data can further include type of the operation performed, e.g. insert, update, retrieve. Further yet, a classification of service is retrieved, e.g. request-response service, notification service etc.

Accordingly, after the above steps, details regarding the entities, the attributes of the entities, interactions involved using the entities, and the relationships between the various entities are identified. Additionally, external system which form the interactions is captured along with the operations invoked on the systems and the input/output values for such interactions. It should be noted that the “entities” as described herein include computer data structures (e.g. objects) that are automatically instantiated and attributes populated by the knowledge graph generator 115.

Further, the knowledge graph generator 115 enhances the process-specific knowledge graph 120 with “entity source”, “states”, “conditions”, and “actions”—by analyzing the static process definitions (workflow and rules for decisions); and by analyzing the historical data (using machine learning algorithms) generated by process execution engines in the RPA system 100 when executing the process with manual intervention. Such information can be derived by evaluation of a process logs, audit trail logs, and other such information associated with the process.

For example, historical data of process execution can include a sequence of path traversed, the input parameters for each operation, output parameters, and errors encountered. For example, the path traversed can be Start→raiseReq→provideInfo→Approval→Accept. Further, the parsing of the ruleset determines the conditions involved. For example, in approval node the ruleset condition if (role is Manager) autoApprove is set to true. Based on the historical data, all the paths traversed by the process engine are analyzed and a flow pattern is captured. Machine learning is used to extract alternate paths in the process-representation 105 and retrieve “states”, “conditions” and “actions” by analyzing process logs and event log data.

Based on the rules, and the entities extracted from the above steps, “states” are constructed with transitions acting as conditions. For example, in the case of travel approval scenario being discussed herein, the following states and sequence of the flow of the states are determined, TravelApprovalRequestRaised, TravelApprovalRequestInProcess, TravelApprovalRequestOnHold, TravelApprovalRequestRejected, and TravelApprovalRequestApproved. The transition between the states is determined by the paths traversed and machine language is used to extract the paths. These transitions identify the valid states the transition can happen and the actions (e.g. wsdl invocations, rule invocations) that determine the transition.

Further, the process-specific knowledge graph 105 is further enhanced with “internal factors” and “external factors” that influence the outcomes. In one or more embodiments of the present invention, such factors are determined by analyzing historic process data, events and logs, various systems-of-records (databases and documents) like policies, regulation, streaming events, feeds etc.

For example, based on the evaluating the process flow logs, event logs, parsing the process-representation 105, the rules that are part of the process execution are classified as internal factors. For example, these internal factors can be either from rules (decision nodes): if local skills exist, is travel request for maintenance or new deal, is maintenance valid and fields from systems of records like database, employeeRole, employeeBand. These internal factors are evaluated based on the process flow and values for the conditions that can be determined directly from electronic data sources such as databases and the condition(s) to make a decision based on these can also be determined from the electronic data sources. For example, the electronic data source can include a policy document that specifies that an employee that is designated a particular role cannot travel beyond a certain distance. Accordingly, the RPA system 100 can execute the process flow according to the condition by accessing corresponding information fields.

In one or more examples, the knowledge graph generator 115 identifies the policies that are not part of the process flow but instead are executed as part of manual/human intervention. For example, in the travel approval process flow factors such as travel freeze, approval criterion based on pending client deal, current client sentiment, a strategic customer can influence a human decision maker to approve/disapprove the travel request. These are classified as external factors and the manifestation of these external factors can be in policy documents, box folders, feeds etc. It should be noted that a “policy” includes one or more overarching rules and it may or may not be used in the process. Depending upon a specific situation, policies can be overridden. For instance, in the travel assessment, the requestor may provide valid reasons like ‘travel to fix an issue in a software’, however, at an organization level the policy may be that of a travel freeze. This travel freeze may or may not be included as part of the process and qualifies as an external factor in some cases. Determining, dynamically, that the policy is an external factor for the process flow is an improvement provided by one or more embodiments of the present invention.

The knowledge graph generator 115 automatically maps the process flow execution results against input variables, values obtained during process flow, the values of “internal factors” and the values of “external factors”. For the mapping, the process-specific knowledge graph 120 is enhanced with “entity source”, “states”, “conditions” and “actions” by analysing the static process definitions (workflow and rules for decisions); and by analysing the historical data (using machine learning algorithms) generated by process execution engines. Based on the historical data, all the paths traversed by the process engine are analysed and flow pattern is captured. Based on the rules, and the entities extracted, states are constructed with transitions acting as conditions.

Further, in one or more embodiments of the present invention, the weightage of the external factors as compared to input factors is adjusted/configured. For example, travel for PMR fix of customer not having local skills is approved in Q2 but rejected in Q3 due to travel freeze which is an external factor. In such cases the knowledge graph generator 115 deems that “travel freeze” has more weightage than “presence of local skills” rule.

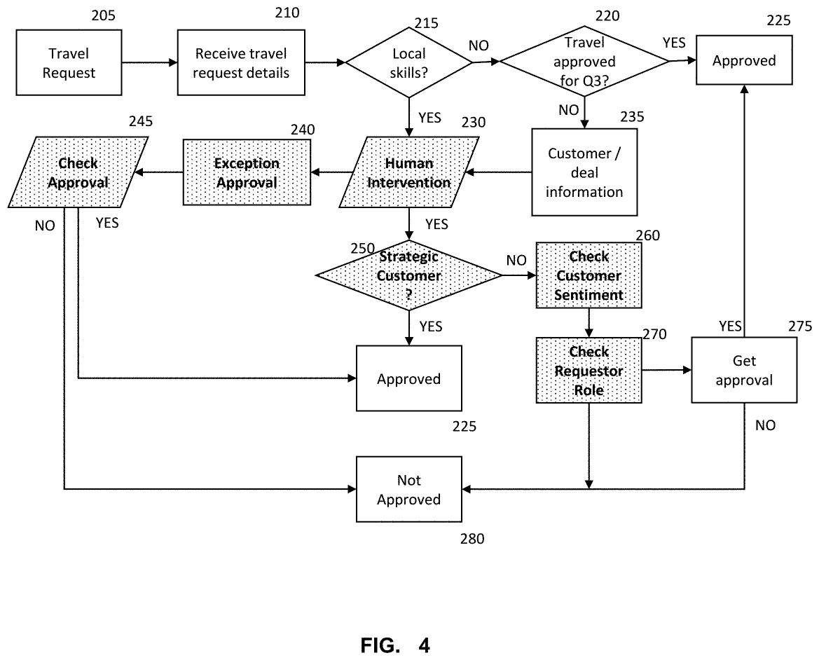

FIG. 4 depicts a flowchart of a process execution by an RPA system according to one or more embodiments of the present invention. Here, execution of the specific process of travel request approval is shown, however, it is understood that embodiments of the present invention are not limited to this specific type of process and/or the specific example described herein. As has been described herein, the method beings with receiving a travel request, at 205. Further, details for the request are received, such as the destination, origin, reason for travel, and various other attributes, at 210. In the example, it is determined whether local skills are available (e.g. person at the destination) to handle the problem (situation), which is noted as the reason for the travel, at 215. If local skill is not available, and if traveling is permitted at this time of year per organization's policies, the travel request is approved, at 220 and 225. These steps can be performed automatically by the RPA system 100, without any manual intervention once the input data for the travel request is received.

However, if local skills are available (215) or if travel requests are not approved in the current business cycle (220), in the presently available solutions, human intervention is performed to evaluate whether to approve the travel request, at 230. In case of travel freeze, additional information regarding why an exception should be made is obtained from the requestor 101 101, at 235. For example, customer information, deal information, for which the travel is being requested, is obtained. One or more approvers (humans) in the organization review the travel request and associated information to determine whether an exception is to be made, at 240. If the exception is approved, the travel request is approved, at 245 and 225. If the exception is not approved, the travel request is not approved, at 245 and 280.

Such human intervention can include checking if the customer for which the travel is being requested is a strategic customer for the organization, at 250. It should be noted that being a strategic customer is one possible exception that is described herein for explanation, and that in other cases, various other exceptions are possible for approving the travel request. If the customer is determined to be a strategic customer, the travel request is approved at 225. If the customer is determined as not strategic, the human intervention may further include checking one or more external factors, such as the customer's sentiment at the time of the requested travel, at 260. Additionally, a role of the requestor 101 can be checked in one or more examples, at 270. For example, of the requestor 101 is not at a predetermined hierarchical level in the organization, the travel request can be disapproved. If the customer sentiment and requestor 101 role meet a certain condition, further approval may be sought from a person in a particular role at the organization, such as a vice president, director, etc., at 275. The travel request can either be approved (225) or disapproved (280) by that person.

In this process the human intervention steps (shown with patterned background in FIG. 4), are not automated and can cause a bottle neck, as described herein. one or more embodiments of the present invention facilitate not just automating the steps by the RPA system 100, but also automatically determining the rules/conditions that are used for the decision making process during the human intervention. This facilitates replacing the human intervention by an artificial intelligence, and having a practical application where a travel requestor 101 can interact with an artificially intelligent RPA system 100 that can provide a travel request approval/disapproval in a transparent and efficient manner.

According to one or more embodiments of the present invention, the RPA system 100 is facilitate to determine actionable insights from the knowledge graph 120, the insights being used as an addendum for executing the process. The derivations (based on influencing factors) from the knowledge graph 120 include both, implicit information as well as the explicit data. The derivations of the knowledge graph 120 are consumed for the process execution depending on the context, content, and configuration. The RPA system 100 accordingly provides a dynamic behavior where the process execution assimilates the external factors and influences the decision making automatically.

Referring back to the RPA system 100 in FIG. 3, the knowledge graph 120 that is generated is used by a decision tree maker 125 to generate a process execution model 130 (decision tree). An execution engine 150 uses the decision tree 130 to execute the process. The decision tree 130 includes “content”, which includes the entities associated with the process; “context”, which includes values of the entities at the time of process execution, and “contract”, which includes the factors/values that the entities hold or the condition and actions present in the process specific knowledge graph 120. For example, in the travel request scenario described herein, the following values can be used for the content—requestor 101 employee, TravelRequest, customer. Further, the values of the entities as part of the execution process form the context like “Travel for PMR”, “Travel for Customer Deal”, CustomerName “XYZ Corporation”, and the like. Further yet, rules that govern the transition like “travelFreeze during 3Q”, “CustomerSentiment”, and other such rules form the contract.

The content, context, and contract values along with the input values and the final results of the process are mapped. The content, context, and contract are constituents of the process. Identification of these three parameters from the process and extraction constitute the “mapping”. The mapping here identifies these parameters and maps it into process specific knowledge graph 120. Additionally the data flow across each steps is captured via process logs, audit trail logs. The decision tree 130 includes the knowledge base of entities and relationship with the corresponding parameters, stored in the form of metadata. This is manifested as a custom decision tree structure. Depending upon the final result of the process, the weightage of all the parameters is updated. Here, the “final result” is the knowledge graph 120 that is a result of evaluating the entities, transitions, conditions, content, context, and contract values. The execution engine 150 uses the decision tree 130 based on the weightages assigned to the parameters to execute the process.

The values of the parameters associated with the decision tree 130 are updated using input from the requester as well as the knowledge graph 120. In one or more examples, an AI conversation generator 135 automatically generates a conversation workflow 140. The conversation workflow 140 is used by the execution engine 150 to have an interactive session with a requester that wants to initiate the process, for example, provide a travel request.

The execution engine 150 uses the decision tree 130 as the process execution model and further uses an interactive chat-based interface (e.g. Watson Assistant), in a contextual manner that understands the current state of the request and the internal and external factors, and asks for only relevant data that is required for the decision making. The custom decision tree 130 created as described above provides the process execution model and the flow of control for executing the process is determined based on the response provided to each query. Based on the entities identified in the process and depending upon the input variables as required by the decision tree 130, the AI conversation generator 135, such as, Watson Assistant API, is invoked to create intents and entities. Further, based on the flow of the decision tree 130 dialog nodes are constructed via the conversation generator 135. The internal and external factors are used as context variables in the conversation generator.

For example, a sequence of operations is determined with each operation corresponding to an entity in the process being executed. The sequence of dialog flow used and generated by the conversation generator is corresponding to that defined in the decision tree 130. Based on the entity names, intents are identified. For example, the entity names in the process flow are identified during the process inspection (static and dynamic flow). The process of mapping these entity names to intents may be done manually as a pre-configuration step. Further, the context variables for the conversation generator 135 are identified based on the internal and external factors and the weightage (importance).

During the execution of the process by the execution engine 150, depending upon the external factors for the process the RPA system 100 listens to any changes. For instance in the case of travel approval process, the travel freeze during a certain time period, such as Q3 can be determined based on an update to the policy documents in the process-representation 105. According to one or more embodiments of the present invention, an adapter is configured to monitor the changes in the process-representation 105. The adapter notifies the knowledge graph generator 115 and the decision tree generator 125 whenever the process-representation 105 is modified. Depending upon the change, the decision tree 130 is updated. For instance, if the travel freeze is set to current quarter, all travel unless it is for a strategic customer or strategic deal is rejected. Accordingly, the relevant questions generated by the conversation generator 130 are to determine if the travel is for strategic customer or strategic deal.

From an execution standpoint the travel freeze factor (identified as external factor herein) is provided the highest weightage in the example scenario described herein. Accordingly, execution of the travel request approval begins based on the travel freeze factor. Only if the requestor 101 provides responses that identify that the travel is for strategic customer/deal, does the flow proceed with further questions to determine further approval/disapproval factors, else a notification indicating the travel approval rejected is provided.

In one or more examples, the conversation generator 135 is trained to interact, e.g. have a question-answer session, with the requester using the knowledge-graph 120 that is extracted from process-representation 105. According to one or more embodiments of the present invention, the training is performed in an automated manner. The trained conversation generator 135 is invoked by the execution engine 150 to contextually ask questions based on the present external factors, policy updates (obtained from integrations, updates made to the knowledge graph 120/decision tree 130 in the backend), and drive the desired outcome.

For example, consider an example where the WATSON™ chat generation API is used as the conversation generator 135. Based on the changes in external factors and depending upon the weightage, a context parameter is populated in the conversation generator via the API. Depending upon the values of the context parameters the queries posed by the conversation generator 135 change. For instance, if the travel freeze is in place for the current quarter, the dialog flow to first check the context parameter “does travel freeze apply=true”, generates queries for checking travel dates.

Referring to FIG. 3, it should be noted that each of the miner 110, knowledge graph generator 115, decision graph generator 125, conversation generator 135, and the execution engine 150, can be a separate computing device communicatively coupled with each other. Each of these computing devices can communicate with each other either using wired communication, wireless communication, or a combination thereof.

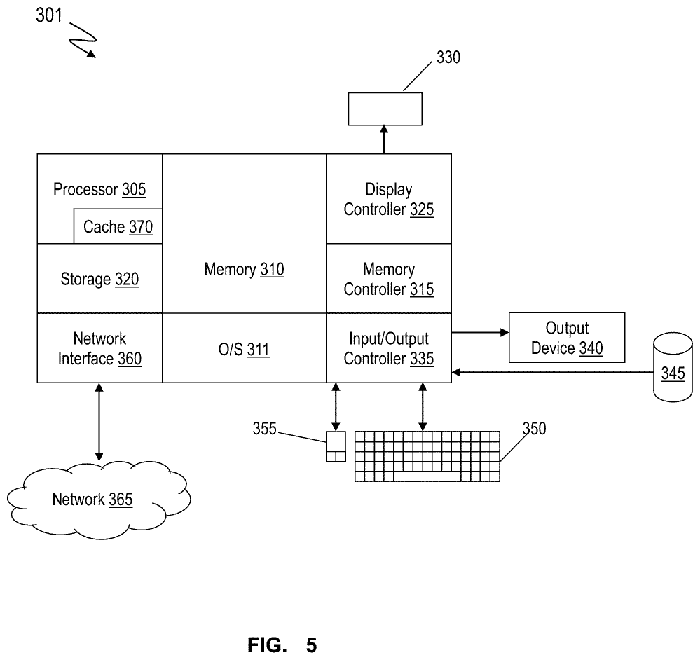

FIG. 5 depicts a system 300 that can be used as a computing device to implement one or more components or a combination thereof according to one or more embodiments of the present invention. The system 300 may be a communication apparatus, such as a computer. For example, the system 300 may be a desktop computer, a tablet computer, a laptop computer, a phone, such as a smartphone, a server computer, or any other device that communicates via a network 365. The system 300 includes hardware, such as electronic circuitry.

The system 300 includes, among other components, a processor 305, memory 310 coupled to a memory controller 315, and one or more input devices 345 and/or output devices 340, such as peripheral or control devices, that are communicatively coupled via a local I/O controller 335. These devices 340 and 345 may include, for example, battery sensors, position sensors, indicator/identification lights and the like. Input devices such as a conventional keyboard 350 and mouse 355 may be coupled to the I/O controller 335. The I/O controller 335 may be, for example, one or more buses or other wired or wireless connections, as are known in the art. The I/O controller 335 may have additional elements, which are omitted for simplicity, such as controllers, buffers (caches), drivers, repeaters, and receivers, to enable communications.

The I/O devices 340, 345 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 305 is a hardware device for executing hardware instructions or software, particularly those stored in memory 310. The processor 305 may be a custom made or commercially available processor, a central processing unit (CPU), an auxiliary processor among several processors associated with the system 300, a semiconductor based microprocessor (in the form of a microchip or chip set), a macroprocessor, or other device for executing instructions. The processor 305 includes a cache 370, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 370 may be organized as a hierarchy of more cache levels (L1, L2, and so on.).

The memory 310 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 310 may incorporate electronic, magnetic, optical, or other types of storage media. Note that the memory 310 may have a distributed architecture, where various components are situated remote from one another but may be accessed by the processor 305.

The instructions in memory 310 may include one or more separate programs, each of which comprises an ordered listing of executable instructions for implementing logical functions. In the example of FIG. 5, the instructions in the memory 310 include a suitable operating system (OS) 311. The operating system 311 essentially may control the execution of other computer programs and provides scheduling, input-output control, file and data management, memory management, and communication control and related services.

Additional data, including, for example, instructions for the processor 305 or other retrievable information, may be stored in storage 320, which may be a storage device such as a hard disk drive or solid state drive. The stored instructions in memory 310 or in storage 320 may include those enabling the processor to execute one or more aspects of the systems and methods described herein.

The system 300 may further include a display controller 325 coupled to a user interface or display 330. In some embodiments, the display 330 may be an LCD screen. In other embodiments, the display 330 may include a plurality of LED status lights. In some embodiments, the system 300 may further include a network interface 360 for coupling to a network 365. The network 365 may be an IP-based network for communication between the system 300 and an external server, client and the like via a broadband connection. In an embodiment, the network 365 may be a satellite network. The network 365 transmits and receives data between the system 300 and external systems. In some embodiments, the network 365 may be a managed IP network administered by a service provider. The network 365 may be implemented in a wireless fashion, for example, using wireless protocols and technologies, such as WiFi, WiMax, satellite, or any other. The network 365 may also be a packet-switched network such as a local area network, wide area network, metropolitan area network, the Internet, or other similar type of network environment. The network 365 may be a fixed wireless network, a wireless local area network (LAN), a wireless wide area network (WAN) a personal area network (PAN), a virtual private network (VPN), intranet or other suitable network system and may include equipment for receiving and transmitting signals.

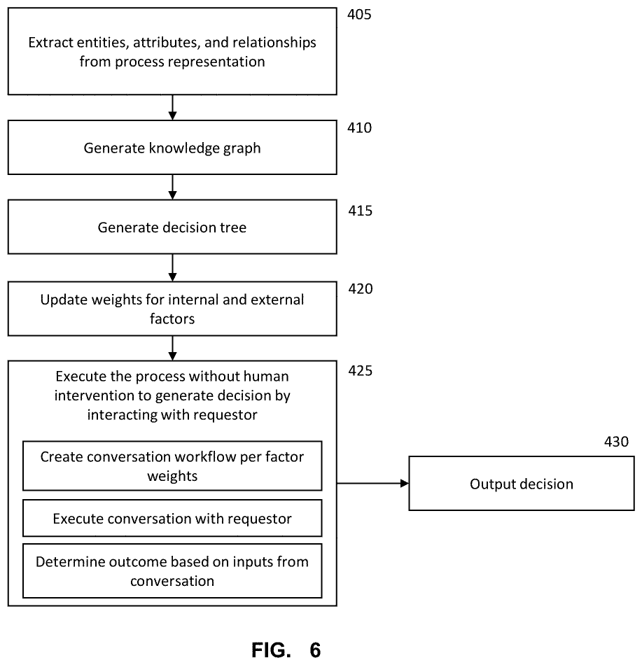

FIG. 6 depicts a flowchart of a method for automating execution of a process that includes decision making according to one or more embodiments of the present invention. The method includes extracting entities, attributes, and relationships from process representation 105, at 405. The extraction is performed by the miner 110. The miner 110 also identifies tasks, actions, and transitions from the process representation 105.

Further, the method includes generating the knowledge graph 120, at 410. To build the knowledge graph 120 the knowledge graph generator 115, in addition to the information identified by the miner 110, determines the details of collaborating participants like the web services, service components, adapters, events, etc. While the miner 110 identifies the details specific to the process flow, this provides only a partial flow (static process flow). For instance, the miner 110 does not provide details about collaborating wsdl/SCA, and/or JCA components. The identification of these components and their influence on the process is done by the knowledge graph generator 115. Similarly, discovery of system of records such as database and the entities that are being used in the process is performed by the knowledge graph generator 115 using one or more adapters. Here, an “adapter” refers to technique used to access an external system. As the process can be interacting with different external (third party) systems, the adapters provide an abstraction in terms of connectivity, access, retrieval, updating of the external system during the process flow. For example, an application programming interface, a protocol, or any other specific access mechanism used for such access can be included in, or referred to as the adapter. The knowledge graph generator 115 provides not just identification of artifacts but also provides the relationship among the artifacts when generating the knowledge graph 120. These relationships also include interactions with the various third party systems identified by the knowledge graph generator 115. This identification of third party systems is done based on the process logs, audit trail logs along with the request parameters at each step in the process representation 105.

The knowledge graph generator 115 accordingly determines and stores in the knowledge graph 120, which is specific to the process being automated, at least a. Sequence of operations, b. Data flow across the process, c. External operations/invocations (performed by third party systems), d. Identification of the states in the system during execution of the process, e. Actions/transitions which cause change of state, and f Pre-conditions and post-conditions for actions/transitions. Additionally, this step also processes the event logs to identify the boundary and states details in one or more embodiments of the present invention. In one or more embodiments of the present invention machine learning algorithms for pattern recognition are used on the mined data from the miner 110.

The method further includes generating the decision tree 130, at 415. The decision tree is a hierarchical data structure that is based on the knowledge graph 120. The decision tree 130 is traversed during the process execution by the execution engine 150 based on one or more conditional. In one or more examples, a custom data structure based on Petri net data structure is created to represent the decision tree 130. The custom data structure is hierarchical and captures the states, transitions between the states, and the action required for the transition between states. According to one or more embodiments of the present invention, the Petri net data structure is a directed bipartite graph, in which nodes represent transitions (i.e. events that may occur) and places (i.e. conditions). The Petri net further includes directed arcs that describe which places are pre- and/or post-conditions for which transitions.

In one or more examples, the action/transition, pre-condition and post-condition are mapped to intents, entities, actions and context from the knowledge graph 120. The mapping of the states, action, and entities includes at least the following: a. Identification of the variables form the part of the local state; b. Based on the sequence element in the process representation 105, identify the execution order of the operations. For each operation the input parameters are obtained and the operation is mapped to the action/transition and an intent is created based on the name of the operation.

Creation of the decision tree 130 includes identifying fields of the Petri net data structure from the knowledge graph 120. The fields represent the parameters that are used for A metadata model of the decision tree 130 is stored. The creation of the decision tree 130 also includes editing one or more nodes.

Further, the method includes assigning weights to the internal and external factors that are identified by the machine learning, at 420. The assignment of weights can be dependent on the process being automated. In some cases external factors such as organization policies are given maximum priority over the internal conditions. The weights can be preconfigured for particular internal and/or external factors. For example, in the travel request scenario, factors such as travel freeze that cause a one-step rejection of the request, are given higher weight than other weights.

The method further includes executing the process without human intervention to generate decision by interacting with the requestor 101, at 425. The execution engine 150, for the execution, creates the conversation workflow 140 per the factor weights. The conversation workflow 140 is executed via a user interface, for example a graphical user interface (GUI). In one or more examples, the GUI indicates at least the following: a. sequence of operations, with each operation corresponding to an entity; b. based on the entity name, intents are identified based on the conversation terms used; and c. event listeners which monitor changes in the process representation 105 are identified.

Further, the metadata model of the decision tree 130 is used to generate the conversation workflow 130 automatically using the conversation generator 135, such as one or more APIs associated with WATSON™ for generating one or more interactive dialogs. The communication workflow can include dialogs that the requestor 101 can respond and interact with either using a text, an audio, and/or a visual user interface. The conversation workflow 130 includes one or more questions that the RPA system 100 asks the requestor 101 regarding the request that the requestor 101 has initiated.

The questions are generated automatically using an artificial intelligence/machine learning algorithms. The questions are provided to the requestor 101 via a dialog in the GUI. The factors with higher weights are used to generate dialogs in the conversation workflow 130 first, ahead of dialogs related to other factors with lower weights.

The data input by the requestor 101, in response to the questions, is used to traverse the decision tree 130. The inputs received via the GUI along with the internal/external factors are used to determine a state in the process execution. In one or more examples, the state is stored. Based on the state the process continues to generate further dialogs to obtain other input data from the requestor 101. In one or more examples, the GUI also displays a traversal of the decision tree 130 during the process execution.

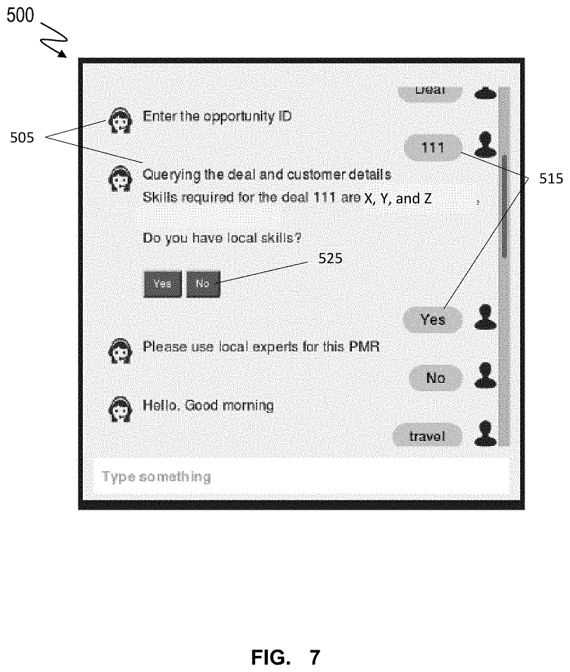

FIGS. 7-9 depict parts of an example user interface according to one or more embodiments of the present invention. The portion 500 of the GUI displays an interactive chat session that the RPA system 100 uses to interact with the requestor 101 to ask questions 505 and receive answers 515 in response to obtain values for the one or more parameters that are used to traverse the decision tree 130. It should be noted that although a textual exchange is depicted, in one or more embodiments of the present invention, the question-answer session can be conducted using speech/audio, or any other medium. In one or more examples, the GUI 500 can also include interactive elements 525 that the requestor 101 can use to provide parameter values.

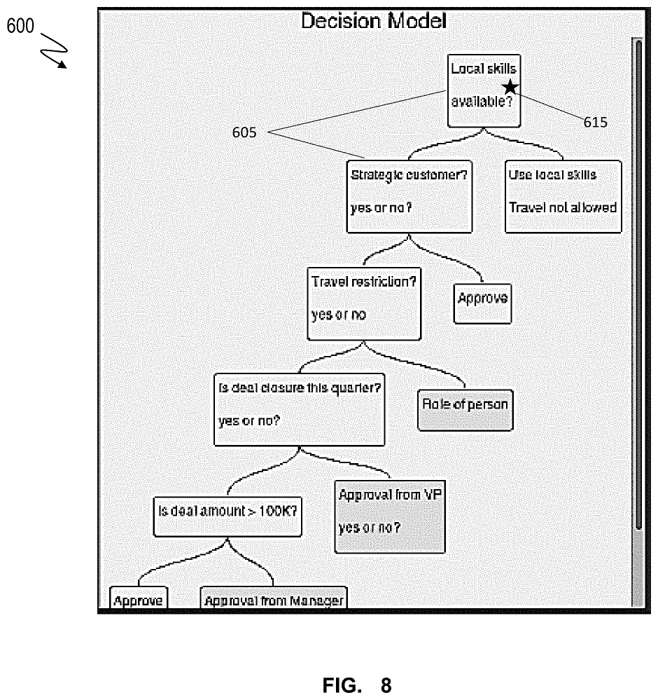

Further, in FIG. 8 a portion 600 of the GUI depicts a visual representation of the traversal of the decision 130 as the requestor 101 provides one or more answers 515. The portion 600 depicts one or more nodes 605 of the decision tree 130 along with visual notification 615 of one or more nodes that have been and/or are being traversed.

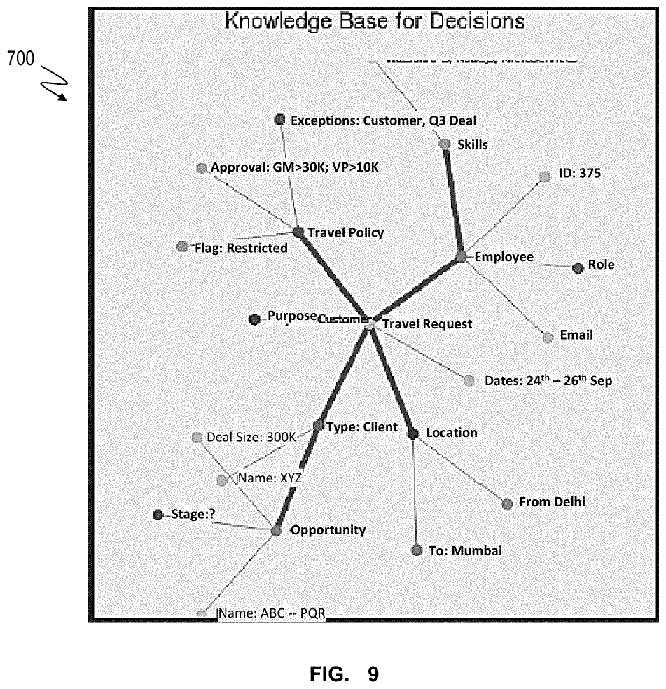

According to one or more embodiments of the present invention, as shown in FIG. 9, a portion 700 of the GUI depicts a visual representation of the knowledge graph 120 with the parameter values for the internal and external factors for the present process execution filled in. The values for the parameters can be dynamically updated as the requestor 101 provides them via the portion 500.

In one or more examples, the GUI also supports modification of the entity, intent and action parameters. Once the user finalizes the sequence and requests final outcome of the decision making process (e.g. clicks on user interface “OK”), the intent, entities, and action is populated to the decision tree 130. The outcome of the decision tree 130 is then output to the requestor 101, at 430 (FIG. 6).

In one or more examples, the RPA system 100 monitors for events of interest being initialized, for example, a requestor 101 initiating a process execution, a change in policy causing the knowledge graph 120 (and hence decision tree 130) to change, etc. An action is triggered in the decision tree 130 based on the events, in one or more examples. The action on the decision tree 130 can result in a state change, which in turn invokes a context change in the execution engine 150. Depending upon the context change the subsequent flow of the process gets altered and a new query is generated by the execution engine. The change in context further updates the question-answers (505, 515) from the conversation generator 135 and this makes the process flow context specific and dynamic.

Accordingly, the decision making can be executed without any manual intervention.

One or more embodiments of the present invention accordingly facilitate a robotic process automation system that can automatically create a decision and process model, which is trained on domain knowledge and can formulate rules and workflow to implement a process using artificial intelligence. The model is derived from contextualized data and information. The decision making process is optimized for using data minimization approach to achieve complex objective. Further, the model is executed and automated by using automation. During the execution, process data is fed back into the model, to correct and update itself to react for changes. One or more embodiments of the present invention solution uses AI for generating the decision and process model, which is stored as a decision tree which includes various entities, rules and workflow required to execute the process. Further, according to one or more embodiments of the present invention the decision tree is used as an input to an artificial conversation generator to initiate a conversation with a user to receive one or more inputs to execute the process. The conversation with the user is dynamically generated based on any updates to the process that is being executed.

Embodiments of the present invention provide a practical application or technical improvement over technologies found in the marketplace, particularly for automating a decision making process. Embodiments of the present invention automate modeling the decision making process, and further automate an interaction with one or more users to obtain parameter values that are to be used for executing a decision making process automatically.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source-code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
automatically generating, using machine learning, a data structure that stores a knowledge graph for a decision making process that is to be automated, the knowledge graph comprises one or more entities, one or more states of each of the entities, and transitions for each of the states, wherein the knowledge graph is generated automatically based on execution logs of the decision making process;
creating, from the knowledge graph, a decision tree that represents conditions for one or more parameters that cause the entities in the knowledge graph to transition from a first state to a second state;
automatically generating a conversation flow to obtain values for the one or more parameters;
performing, via a graphical user interface, a machine-human conversation with a user to obtain the values of the one or more parameters, the machine-human conversation comprising one or more dialogs from the conversation flow to converse with the user;
executing the process automatically by traversing the decision tree using the values of the one or more parameters; and
notifying the user of a result of executing the process.

2. The computer-implemented method of claim 1, further comprising, assigning a weightage to the one or more parameters.

3. The computer-implemented method of claim 1, wherein the one or more parameters comprise internal parameters that are derived from the execution logs.

4. The computer-implemented method of claim 1, wherein the one or more parameters comprise external parameters that are derived from one or more data sources that are external to the execution logs.

5. The computer-implemented method of claim 4, wherein the one or more data sources include a policy document governing the decision making process.

6. The computer-implemented method of claim 5, further comprising, monitoring the one or more data sources, and in response to a change in the policy document, updating the knowledge graph.

7. The computer-implemented method of claim 1, further comprising, parsing, from the execution logs a static workflow of the decision making process.

8. A system comprising:
a memory; and
a processor coupled to the memory, the processor configured to perform a method for automating a decision making process, the method comprising:
automatically generating, using machine learning, a data structure that stores a knowledge graph for the decision making process that is to be automated, the knowledge graph comprises one or more entities, one or more states of each of the entities, and transitions for each of the states, wherein the knowledge graph is generated automatically based on execution logs of the decision making process;
creating, from the knowledge graph, a decision tree that represents conditions for one or more parameters that cause the entities in the knowledge graph to transition from a first state to a second state;
automatically generating a conversation flow to obtain values for the one or more parameters;
performing, via a graphical user interface, a machine-human conversation with a user to obtain the values of the one or more parameters, the machine-human conversation comprising one or more dialogs from the conversation flow to converse with the user;
executing the process automatically by traversing the decision tree using the values of the one or more parameters; and
notifying the user of a result of executing the process.

9. The system of claim 8, wherein the method further comprises assigning a weightage to the one or more parameters.

10. The system of claim 8, wherein the one or more parameters comprise internal parameters that are derived from the execution logs.

11. The system of claim 8, wherein the one or more parameters comprise external parameters that are derived from one or more data sources that are external to the execution logs.

12. The system of claim 11, wherein the one or more data sources include a policy document governing the decision making process.

13. The system of claim 12, wherein the method further comprises, monitoring the one or more data sources, and in response to a change in the policy document, updating the knowledge graph.

14. The system of claim 8, wherein the method further comprises, parsing, from the execution logs a static workflow of the decision making process.

15. A computer program product comprising a computer readable storage medium having program instructions embodied therewith, the program instructions executable by a processing circuit to cause the processing circuit to perform a method for automating a decision making process, the method comprising:
automatically generating, using machine learning, a data structure that stores a knowledge graph for a decision making process that is to be automated, the knowledge graph comprises one or more entities, one or more states of each of the entities, and transitions for each of the states, wherein the knowledge graph is generated automatically based on execution logs of the decision making process;
creating, from the knowledge graph, a decision tree that represents conditions for one or more parameters that cause the entities in the knowledge graph to transition from a first state to a second state;
automatically generating a conversation flow to obtain values for the one or more parameters;
performing, via a graphical user interface, a machine-human conversation with a user to obtain the values of the one or more parameters, the machine-human conversation comprising one or more dialogs from the conversation flow to converse with the user;
executing the process automatically by traversing the decision tree using the values of the one or more parameters; and
notifying the user of a result of executing the process.

16. The computer program product of claim 15, further comprising, assigning a weightage to the one or more parameters.

17. The computer program product of claim 15, wherein the one or more parameters comprise internal parameters that are derived from the execution logs.

18. The computer program product of claim 15, wherein the one or more parameters comprise external parameters that are derived from one or more data sources that are external to the execution logs.

19. The computer program product of claim 18, wherein the one or more data sources include a policy document governing the decision making process.

20. The computer program product of claim 19, wherein the method further comprises, parsing, from the execution logs a static workflow of the decision making process.
